(19) United States
(12) Patent Application Publication
(10) Pub. No.: US 2012/0255357 A1
(43) Pub. Date: Oct. 11, 2012

(54) SENSOR PACKAGE HAVING INTEGRATED ACCELEROMETER AND MAGNETOMETER

(76) Inventors: Dongmin Chen, Saratoga, CA (US); Haidong Liu, Wuxi (CN); Zhiwei Duan, Wuxi (CN)

(21) Appl. No.: 13/442,299

(22) Filed: Apr. 9, 2012

(30) Foreign Application Priority Data
Apr. 8, 2011 (CN) 201110087553.1
Apr. 8, 2011 (CN) 201110087554.6

(51) Int. Cl. G01P 15/105

(52) U.S. Cl. 73/514.31

(57) ABSTRACT

A sensor package has integrated magnetic and acceleration sensor package structures, where a first wafer is bonded to a second wafer with a cavity defined between them. The magnetic sensor is bonded to the bottom of the first wafer and the acceleration sensor is provided within the cavity. Circuitry to drive the accelerometer and interface with the magnetic sensor is provided on the first wafer.

### CROSS REFERENCE TO RELATED APPLICATIONS

This application claims the benefit under 35 U.S.C. §119(a) of Chinese Application Nos. 201110087554.6 and 201110087553.1 filed on Apr. 8, 2011, which are herein incorporated by reference in their entireties for all purposes.

### BACKGROUND OF THE INVENTION

The proliferation of consumer electronics, especially portable devices such as smartphones and pads has significantly increased the demand for different sensors to implement the functionality and applications provided in these devices. The need for these sensors, e.g., accelerometers and magnetometers for location and direction-based, i.e., compass applications, is has significantly increased and these are now found in even the most basic handheld devices.

Currently, each sensor device, however, has only one function, such as being a two or three axis magnetic sensor, being a three axis accelerometer, a single axis gyro, etc. Furthermore, these single-function sensors often come in larger package sizes, e.g., 3×3 mm. This leads to larger space requirements, and the associated increased costs, for mobile devices in order to accommodate multiple sensing functions.

### BRIEF SUMMARY OF THE INVENTION

Embodiments of the present invention address the shortcomings described above and are directed to a sensor package structure that integrates a three axis accelerometer, a three axis magnetic sensor and an ASIC to interface with these sensors.

In one embodiment,

In one embodiment the sensor package includes a first substrate having an accelerometer structure provided therein and magnetometer circuitry coupled to the first substrate. A second substrate is coupled to the first substrate to enclose the accelerometer structure.

In one embodiment, first circuitry is provided in the first substrate and electrically coupled to the accelerometer structure and the magnetometer circuitry. Further, the first substrate includes a first cavity and the accelerometer structure is provided in the first cavity. The second substrate includes a second cavity and the first and second cavities are in a sealed fluid connection with one another to define a single enclosing cavity.

In another embodiment, a sensor package includes a first substrate having a top surface with a first cavity and first circuitry provided in the first substrate. An accelerometer structure is provided in the first cavity and electrically coupled to the first circuitry and magnetometer circuitry is coupled to the first substrate and electrically coupled to the first circuitry. A second substrate includes a second cavity and the second substrate is coupled to the first substrate such that the first and second cavities are oriented with respect to one another to define a single enclosing cavity.

### BRIEF DESCRIPTION OF THE SEVERAL VIEWS OF THE DRAWINGS

Various aspects of at least one embodiment of the present invention are discussed below with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The figures are provided for the purposes of illustration and explanation and are not intended as a definition of the limits of the invention. In the figures:

FIGS. 1A-2B are representations of a portion of a sensor package in accordance with an embodiment of the present invention;

FIG. 3 is a representation of the arrangement of two wafer portions as part of a sensor package in accordance with an embodiment of the present invention;

FIGS. 4A-4D represent the steps of making a sensor package in accordance with an embodiment of the present invention;

FIG. 5 is an alternate embodiment of a sensor package in accordance with an embodiment of the present invention; and

FIG. 6 is another embodiment of a sensor package in accordance with an embodiment of the present invention.

### DETAILED DESCRIPTION OF THE INVENTION

Chinese Application Nos. 201110087554.6 and 201110087553.1 filed on Apr. 8, 2011, are herein incorporated by reference in their entireties for all purposes.

In the following detailed description, numerous specific details are set forth in order to provide a thorough understanding of the embodiments of the present invention. It will be understood by those of ordinary skill in the art that these embodiments of the present invention may be practiced without some of these specific details. In other instances, well-known methods, procedures, components and structures may not have been described in detail so as not to obscure the embodiments of the present invention.

Prior to explaining at least one embodiment of the present invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

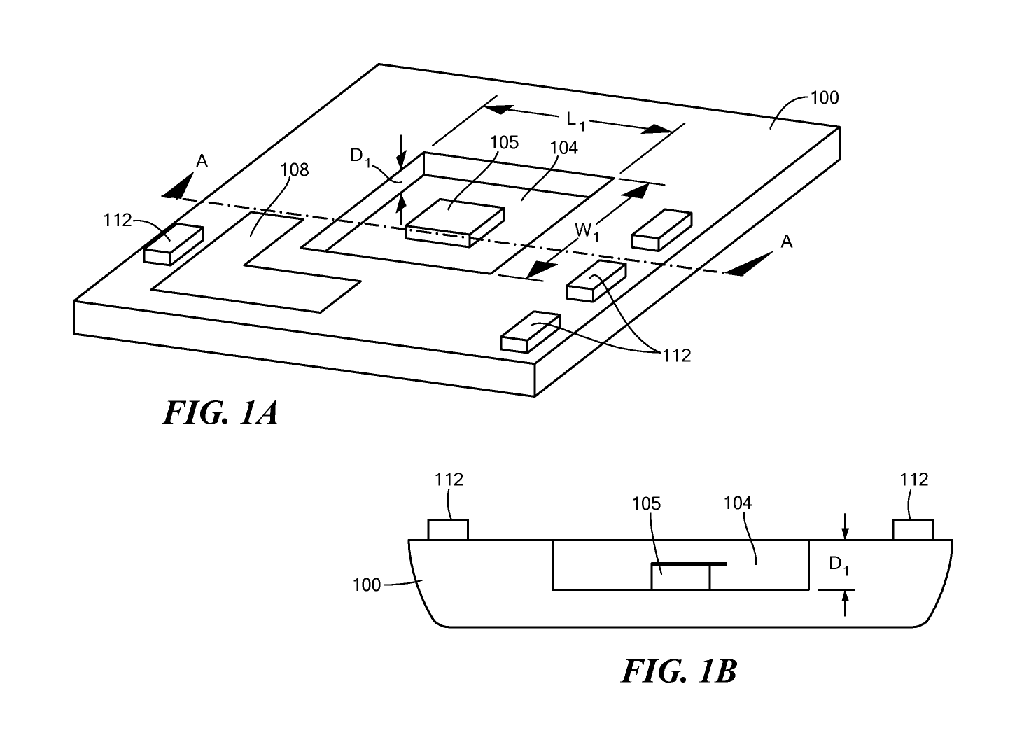

Referring now to FIG. 1A, a first substrate or wafer 100, which may also be referred to as the lower wafer 100, is provided. The first wafer 100 may be a CMOS wafer or made from other material as known to one of ordinary skill in the art. A first cavity 104 is defined in the first wafer 100 with dimensions L₁×Wᵢ×D₁ (length, width, depth). One of ordinary skill in the art will understand how to provide a cavity in the wafer. A multi-axis accelerometer mechanical structure 105, e.g., a three-axis thermal accelerometer, is provided in the first cavity 104. One of ordinary skill in the art will understand that such an accelerometer structure 105, generally in the shape of a bridge, can be provided in the first cavity 104 using photo-processing and etching processes that release the structure from the underlying wafer material.

ASIC circuitry 108 is provided in the first wafer 100 by any of the processes known to those of ordinary skill in the art and receives signals from the accelerometer structure 105 through traces that have been placed in the wafer as is known. The ASIC circuitry 108 is configured to interface with the accelerometer structure 105 in the first cavity 104 in addition to a magnetic sensor, as will be described below. A plurality of metal pads 112 is provided on the upper surface of the first wafer 100 and couple to one or more of the ASIC circuitry 108, the accelerometer structure 105 and any other circuitry that may be provided. A cross-sectional view along the line A-A, as shown in FIG. 1A, is represented in FIG. 1B. Here the accelerometer structure 105 is shown as a functional block. The structure of such devices, however, is known to those of ordinary skill in the art.

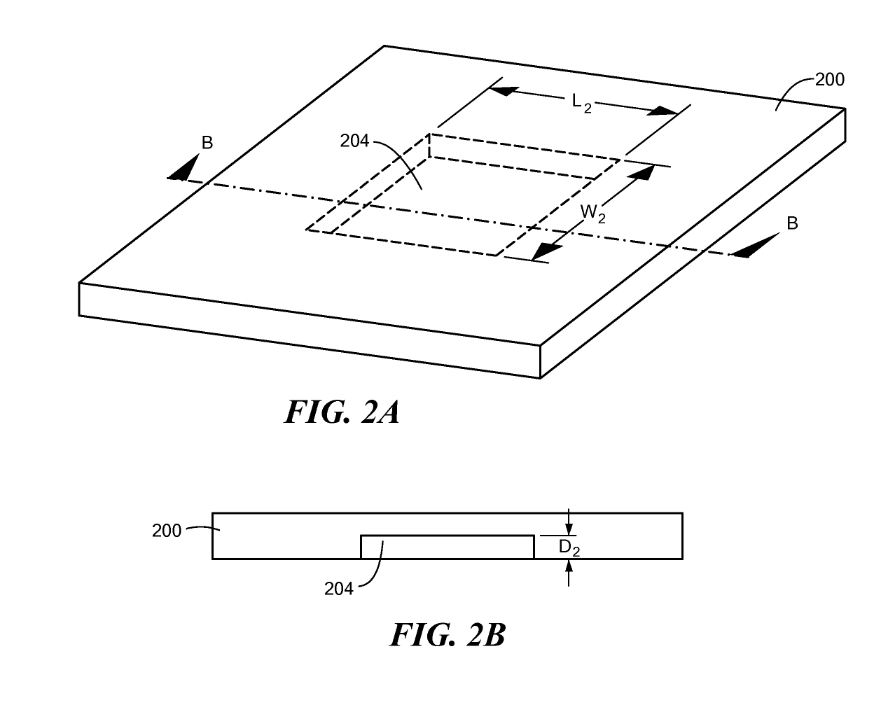

A second substrate or wafer 200, which may be referred to as the upper wafer 200, is made from a same, or different, material with respect to the first wafer 100 as shown in FIG. 2A. A second cavity 204 of dimensions L₂×W₂×D₂ (length, width, depth) is provided in the second wafer 200. The second cavity 204 is sized to be at least the same cross-sectional size as the first cavity 104, i.e., L₂≧L₁ and W₂≧W₁. Of course, one of ordinary skill in the art will understand that the two cavities need not have the same depth value. A cross-sectional view along the line B-B, as shown in FIG. 2A, is presented in FIG. 2B.

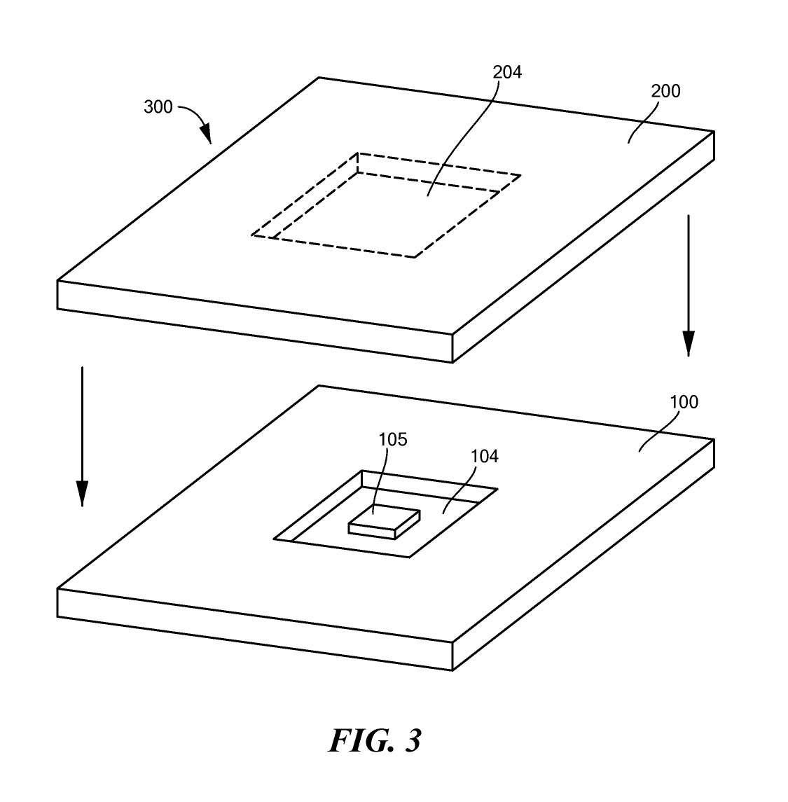

In one embodiment of the present invention, the second wafer 200 is placed over, and is coupled to, the first wafer 100 such that the second cavity 204 covers the first cavity 104. As a result, a larger enclosure or sealed cavity 404 is created between the first and second wafers 100, 200. Depending on the relative sizes of the two cavities, in one embodiment the center of the second cavity 204 and center of the first cavity 104 are generally aligned with one another. An exploded view of a partially assembled sensor package 300 is shown in FIG. 3. Advantageously, as the accelerometer structure 105 will deform during operation, providing the sealed cavity 404 will lessen the chances of damage to the accelerometer structure 105 during operation. Further, when the second cavity 204 is larger than the first cavity 104 then the alignment tolerances of the two cavities can be lessened which aids in ease of manufacturability.

The first and second wafers 100, 200 may be a glass wafer or a silicon wafer. Further, the wafers 100, 200 may be a CMOS wafer. The first and second wafers 100, 200 need not be made from the same material. It should be noted, however, that if two different materials are used, the respective coefficients of thermal expansion (CTE) of the two materials should not differ too much in order to avoid any warpage of the device after being bonded together.

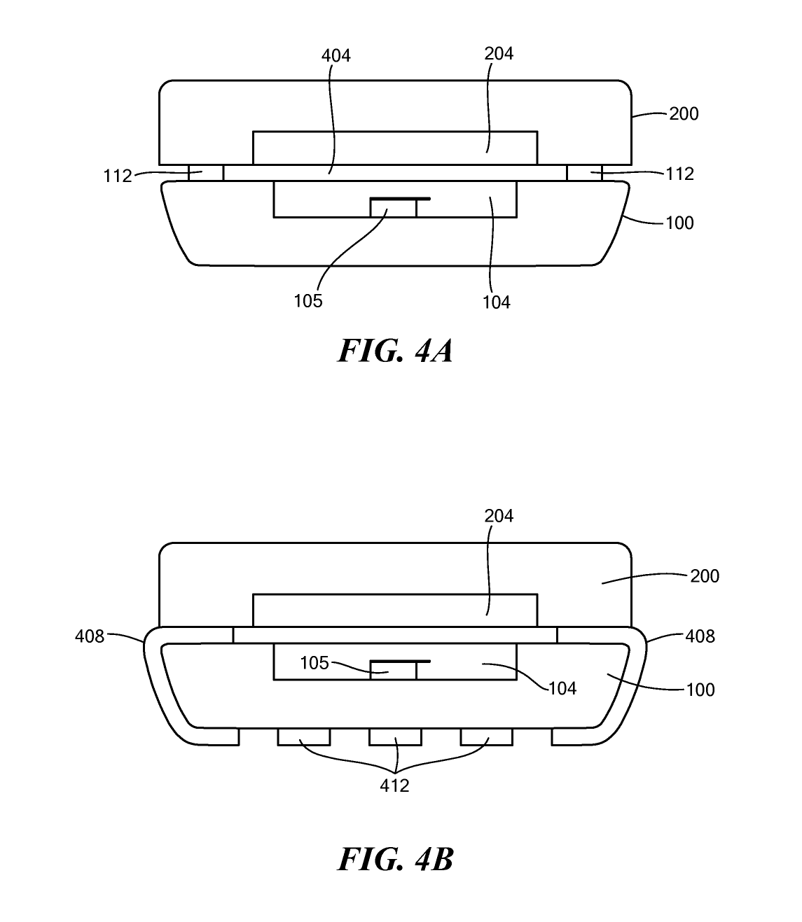

Referring now to FIG. 4A, the second wafer 200 is bonded onto the first wafer 100 such that the larger cavity 404 is defined between them. Many known types of bonding may be used, e.g., eutectic bonding such as Au—Sn, Cu—Sn, Au—Si, etc. Further, known thermo-compression bonding such as Au—Au, Al—A, etc., or epoxy bonding such as 353ND, 353ND-T could be used.

In addition, when the accelerometer structure 105 is a thermo accelerometer, a heavy gas may be sealed in the large cavity 404. In this case, a heavy gas is one that has a large molecular weight such as, for example, SF6, HFC125, HFC227, C3F8, etc. The pressure of the heavy gas in the large cavity 404 should be in the range of 0.5-4.0 atmospheres. Advantageously, providing the second cavity 204 over the first cavity 104 allows for the provided gas to be around, i.e., on all sides of, the accelerometer structure 105. Bonding machines that also insert gas are known to those of ordinary skill in the art.

Metal traces 408 are provided to connect the metal pads 112 to a bottom surface of the first wafer 100, as shown in FIG. 4B. Further, bottom pads 412 are provided on the lower surface of the wafer 100.

A magnetic sensor 416 that senses a magnetic field in one or more axes of orientation includes a plurality of contact pads 418 as shown in FIG. 4C. In one embodiment, the magnetic sensor 416 is a separate Si die with the contact pads 418, i.e., I/O pads, provided thereon. The magnetic sensor 416 is coupled to the bottom pads 412 such that the circuitry within the magnetic sensor 416 is coupled to the ASIC 108. The magnetic sensor 416 could be a single axis or multi-axis sensor.

Ball Grid array (BGA) solder balls 420 are provided on respective metal traces 408 such that the entire assembly 400 may be solder mounted onto an appropriately configured Printed Circuit Board, as shown in FIG. 4D.

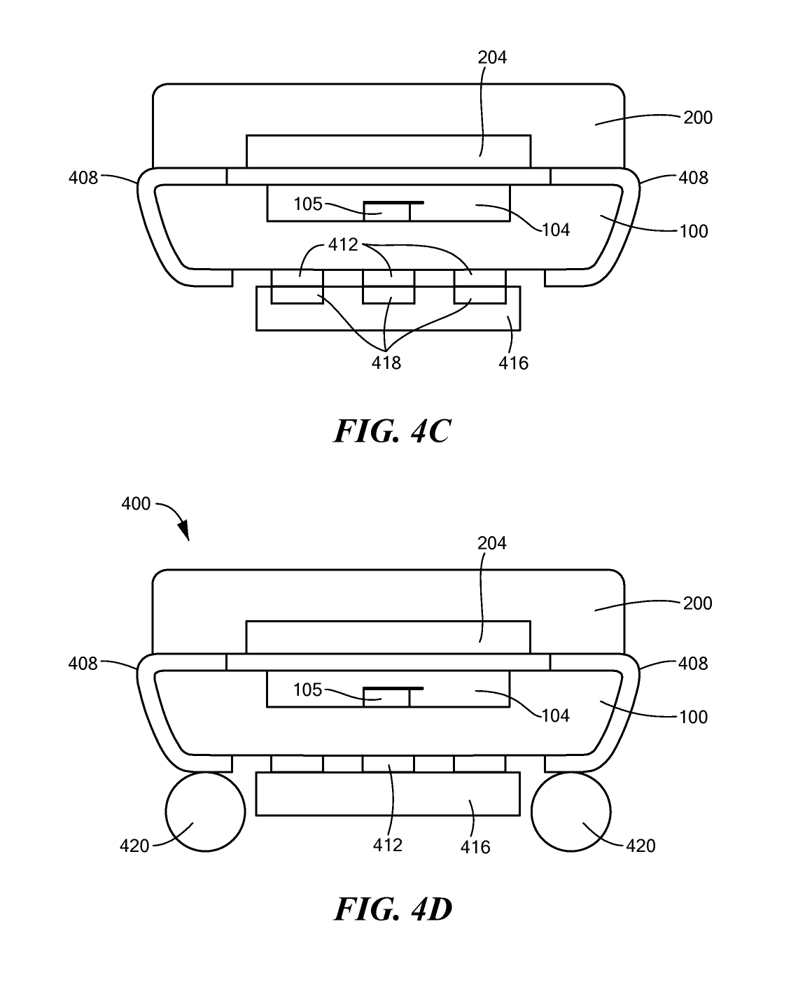

In an alternate embodiment, as shown in FIG. 5, through-silicon vias (TSV) 502 are provided to connect the metal pads 404 through the first wafer 100 to the bottom pads 412 on which the BGA solder balls 420 are attached. The TSVs 502 would be provided when the first wafer 100 is manufactured.

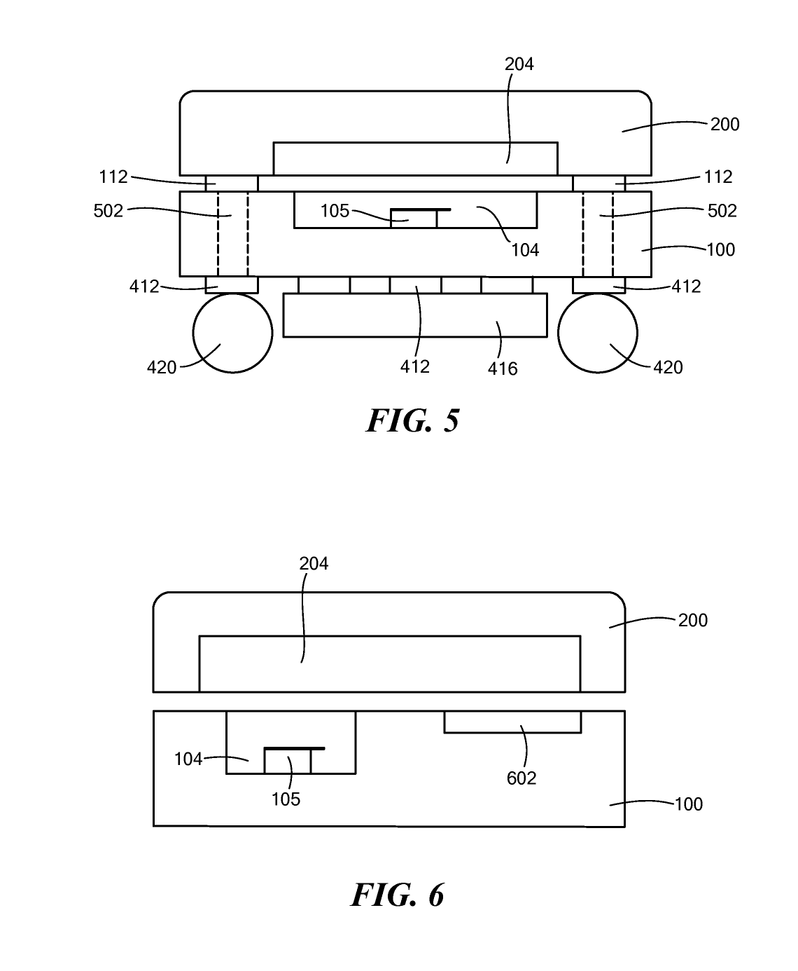

In yet another embodiment of the present invention, magnetic sensor circuitry 602 may be provided in the first wafer 100, e.g., in the upper surface, as shown in FIG. 6, rather than as a separately attached device as shown in the foregoing embodiments. Further, the magnetic sensor circuitry 602 is located such that the second cavity 204 is positioned over it in order to provide some space between the magnetic sensor 602 and the second wafer 200. Although not shown in FIG. 6 for reasons of clarity, one of ordinary skill in the art would understand that the other components described above would also be implemented when the magnetic sensor 602 is provided in the second wafer 200.

A process of manufacturing a sensor package in accordance with an embodiment of the present invention includes the following steps:

1. Prepare the first wafer 100 by implementing the ASIC circuitry 108 and accelerometer structure 105.

2. Etch the first wafer 100 to release portions of the accelerometer structure 105. The etching of the top surface of the first wafer 100 could be by dry etch or wet etch, to release accelerometer structure 105, and form cavity 104. Located the pads 112 on the first wafer 100 top surface but not in the first cavity area 104. The metal pads 112 are provided on the first wafer 100 top surface but not in the first cavity 104 area.

3. Prepare the second wafer 200 with the second cavity 204 which is a little larger than the is first cavity 104 in the first wafer 100. The processing method of forming the second cavity 204 can vary depending upon the material from which it is made. If the second wafer 200 is a glass wafer, then sand blasting, laser drilling or wet etching could be used. If the second wafer 200 is an Si wafer, then dry or wet etching could be used.

4. Bond the first wafer 100 and the second wafer 200 together such that the second cavity 204 in the second wafer 200 covers the first cavity 104 in the first wafer 100 to create the large cavity 404.

5. If the accelerometer structure 105 is a thermal accelerometer, seal a heavy gas in the large cavity 404 and maintain the pressure of the heavy gas in a range of 0.5 - 4.0 atm.

Furthermore, the thicknesses of the wafers 100, 200 could be adjusted by grinding after bonding if a thinner profile is necessary.

6. Lead the metal pads 112 on the first wafer 100 surface to the bottom side by metal traces 408 and use redistribution technology to reassign the locations for all pads. For example, the BGA pads could be arranged in a standard orientation to couple with pads on another device or substrate. Leading the metal pads to the bottom side could be by TSV, as described above.

7. A bumping process can be applied to the magnetic sensor 416, then using flip-chip technology, connect the magnetic sensor 416 to the bottom side of the first wafer 100. Furthermore, in different applications, the bumping process could be implemented by plating, screen printing or ball drop.

8. Form BGA balls on the first wafer 100 bottom side.

One of ordinary skill in the art will understand that the foregoing steps need not be performed in the specific order outlined above. There may be variations of the process where the order of the steps is changed, where some steps are omitted and where some steps are repeated.

Having thus described several features of at least one embodiment of the present invention, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A sensor package having an accelerometer function and a magnetometer function, the package comprising:
a first substrate having an accelerometer structure provided therein;
magnetometer circuitry coupled to the first substrate; and
a second substrate,
wherein the second substrate is coupled to the first substrate to enclose the accelerometer structure.

2. The sensor package of claim 1, further comprising:
first circuitry provided in the first substrate and electrically coupled to the accelerometer structure and the magnetometer circuitry.

3. The sensor package of claim 2, wherein the first circuitry comprises an ASIC.

4. The sensor package of claim 1, wherein the magnetometer comprises magnetometer circuitry on a third substrate, and
wherein the third substrate is mechanically coupled to a bottom surface of the first substrate.

5. The sensor package of claim 4, wherein the mechanical coupling of the third substrate to the bottom surface of the first substrate comprises soldering.

6. The sensor package of claim 1, wherein:
the first substrate comprises a first cavity defined therein,
wherein the accelerometer structure is provided in the first cavity.

7. The sensor package of claim 6, wherein:
the second substrate comprises a second cavity defined therein,
wherein the first and second cavities are in a sealed fluid connection with one another to define a single enclosing cavity.

8. The sensor package of claim 7, wherein the magnetometer circuitry is provided in the first substrate and located within the single enclosing cavity.

9. The sensor package of claim 7, wherein a heavy gas is sealed in the single enclosing cavity.

10. The sensor package of claim 9, wherein the heavy gas is sealed in the single enclosing cavity at a pressure in the range of 0.5-4.0 atmosphere.

11. The sensor package of claim 10, wherein the accelerometer structure comprises a three-axis thermal accelerometer.

12. A sensor package, comprising:
a first substrate having a top surface with a first cavity defined therein;
first circuitry provided in the first substrate;
an accelerometer structure provided in the first cavity and electrically coupled to the first circuitry;
magnetometer circuitry coupled to the first substrate and electrically coupled to the first circuitry; and
a second substrate having a second cavity defined therein,
wherein the second substrate is coupled to the first substrate such that the first and second cavities are oriented with respect to one another to define a single enclosing cavity.

13. The sensor package of claim 12, wherein the respective centers of the first and second cavities are substantially aligned with one another.

14. The sensor package of claim 12, wherein the first circuitry comprises an ASIC.

15. The sensor package of claim 12, wherein the magnetometer circuitry is provided in the first substrate and located within the single enclosing cavity.

16. The sensor package of claim 12, wherein the second substrate is coupled to the first substrate by at least one of: an epoxy, a glue, eutectic bonding or thermo-compression bonding.

17. The sensor package of claim 12, wherein the first cavity has dimensions of L₁×W₁×D₁ and the second cavity has corresponding dimensions of L₂×W₂×D₂, wherein:
L₂≧L₁ and W₂≧W₁.

18. The sensor package of claim 12, wherein the first substrate and the second substrate are made from the same material.

19. The sensor package of claim 12, wherein the first substrate is made from a first material and the second substrate is made from a second material different from the first material.

20. The sensor package of claim 12, wherein the magnetometer comprises magnetometer circuitry on a third substrate, and
wherein the third substrate is mechanically coupled to a bottom surface of the first substrate.

21. The sensor package of claim 20, wherein the mechanical coupling of the third substrate to the bottom surface of the first substrate comprises soldering.

22. The sensor package of claim 12, wherein a heavy gas is sealed in the single enclosing cavity.

23. The sensor package of claim 22, wherein the heavy gas is sealed in the single enclosing cavity at a pressure in the range of 0.5-4.0 atmosphere.

24. The sensor package of claim 22, wherein the accelerometer structure comprises a three-axis thermal accelerometer.
